(19) United States
(12) Patent Application Publication
(10) Pub. No.: US 2010/0253667 A1
(43) Pub. Date: Oct. 7, 2010

(54) METHOD FOR DETECTING THE ACTUATION OF A CONTROL ELEMENT OF A CONTROL FRONT OF AN INVERTER AND CONTROL FRONT FOR AN INVERTER

(75) Inventors: Christian Angerer, Sierning (AT); Bernhard Grossauer, St. Valentin (AT); Harald Josef Kreuzer, Linz/Donau (AT)

Correspondence Address: COLLARD & ROE, P.C., 1077 NORTHERN BOULEVARD, ROSLYN, NY, 11576, US

(73) Assignee: FRONIUS INTERNATIONAL GMBH, Pettenbach (AT)

(21) Appl. No.: 12/734,734

(22) PCT Filed: Nov. 5, 2008
(86) PCT No.: PCT/AT2008/000398

§ 371 Date: May 19, 2010

(30) Foreign Application Priority Data
Nov. 22, 2007 (AT) A 1897/2007

(51) Int. Cl. G09G 5/00; H02J 3/00

(52) U.S. Cl. 345/211; 307/17

(57) ABSTRACT

The invention relates to a method for detection of the actuation of at least one control element (16) of a control front (14) of an inverter (1) and to a control front (14) for an inverter (1) with at least one control element (16). The method essentially does not affect the efficiency of the inverter (1). The method provides that upon actuation of the at least one control element (16) at one secondary side of a transmitter (15), the transmitter will be placed under load, and the load will be detected and evaluated on one primary side of the transmitter (15) by a control apparatus (8), to which at least one actuated control element is allocated, wherein a voltage signal is applied to the primary side of the transmitter (15) and the actuation at least of one control element (16) is detected and evaluated at the voltage-free and/or unpowered secondary side of the transmitter (15) due to the change in the voltage signals at the primary side of the transmitter (15).

The invention relates to a method for the identification of an actuation of at least one operating element of a front panel of an inverter.

Likewise, the invention relates to a front panel for an inverter with at least one operating element.

Generally, it is known from the prior art that operating elements or front panels with a plurality of operating elements are galvanically isolated from the electronics necessary for the functioning of the device. As a result, it is ensured that the operator of the front panel cannot come into contact with any high voltages or currents and the corresponding standards, which are to be complied with, are fulfilled. The galvanic isolation is often achieved in such a manner that the signals of the operating elements of the front panel are transmitted to a control device via optical couplers, so that the action desired by means of the actuation of the operating elements can be executed. To this end, it is necessary, however that the front panel likewise has electronics which generate corresponding signals for the optical coupler in the case of the actuation of the operating elements. Accordingly, a current supply is necessary for the electronics and for transmitting the signals.

DE 10 2005 001 322 A1 describes a method and a circuit for the galvanically isolated transmission of a signal, wherein a pulse-width-modulated voltage is applied to the primary side of a transformer, in the case of which voltage, different pulse/pause ratios characterise different signal states. With the aid of an electronic circuit on the secondary side of the transformer, a voltage dependent on the pulse/pause ratio of the primary-side voltage is detected, the size of which voltage represents the signal state of the primary-side signal.

Disadvantageous here is the fact that one is concerned here with complex electronics of the front panel, which accordingly have an increased susceptibility to faults. Likewise, it is disadvantageous that a separate current supply is required to this end, which constantly supplies the required electronics with current. This is particularly disadvantageous in the case of devices for which the power consumption affects the efficiency of the device, such as for example in the case of an inverter for a photovoltaic system.

The object of the present invention consists in the creation of an above-mentioned method and a front panel with which the efficiency is essentially not influenced. The method should be as simple as possible to carry out and the front panel should be constructed as simply as possible.

The object according to the invention is achieved with respect to the method in that when actuating the at least one operating element on a secondary side of a transformer, this is loaded and the loading is identified and evaluated on a primary side of the transformer by a control device and is assigned to the at least one actuated operating element, wherein a voltage signal is applied on the primary side of the transformer and the actuation at least of one operating element is identified and evaluated on the voltage- or current-supply-free secondary side of the transformer by means of the changing of the voltage signal on the primary side of the transformer.

Advantageous here is the fact that the signal necessary in the case of the actuation of at least of one of the operating elements is generated by means of the loading of a transformer, as a result of which no current supply is required for the galvanically isolated operating elements of the front panel. Thus, the power consumption of the corresponding device is reduced so that the efficiency is not impaired thereby. The galvanic isolation as well as the loading of the transformer can be realised in a very simple and cost-effective manner. As transformers are to be classified as exceptionally unsusceptible to faults, the realisation is also not susceptible to faults. It is possible in a simple manner for example to use a membrane keypad as front panel and to comply with the required standards at the same time. The required galvanic isolation and the required electrical potentials can be complied with by means of the construction according to the invention. In addition, the required space requirement is reduced considerably by means of a front panel of this type or the front panel can flexibly be adapted to the space requirement present.

It is provided for realisation that operating elements are connected in series to different components so that the voltage signal is changed differently in the case of the actuation of different operating elements. Likewise, it is possible to connect an operating element to a component on the secondary side of the transformer without series connection, so that the secondary side of the transformer is short circuited in the case of the actuation of this operating element.

For assigning the at least one actuated operating element, the changed voltage signal is preferably compared with reference values which are for example stored in the control device.

In this case, it is advantageous if a reference value is stored for each operating element and a reference value is likewise stored or established for combinations of at least two operating elements.

Advantageously, the voltage signal is essentially formed by a rectangular signal. Similar shapes which differ from a rectangular shape, such as a trapezoidal signal, are likewise possible.

In order to get feedback about the actuation of an operating element, a display can be activated in the case of the actuation of an operating element. Preferably light-emitting diodes, which are connected in series or in parallel in addition to the components, are used. The voltage signal is selected in such a manner that the required voltage or the required current for the light-emitting diodes or the like is provided.

Likewise, the object of the present invention is achieved by means of an above-mentioned front panel, wherein the at least one operating element is connected on a secondary side of a transformer, wherein the transformer is loaded in the case of the actuation of the at least one operating element, and a primary side of the transformer is connected to a control device for evaluating the loading and assignment of the at least one actuated operating element, and a device for generating a voltage signal for identifying an actuation at least of one of the operating elements arranged on the voltage- or current-supply-free secondary side of the transformer is connected to the primary side of the transformer.

According to one embodiment of the invention, it is provided that at least one operating element is connected to at least one component as a load in series connection.

Operating elements are advantageously connected in series connection to different components so that the transformer is loaded differently in the case of the actuation of different operating elements.

Further advantages can be drawn from the following description.

The present invention is explained in more detail on the basis of the attached schematic drawings. In the figures:

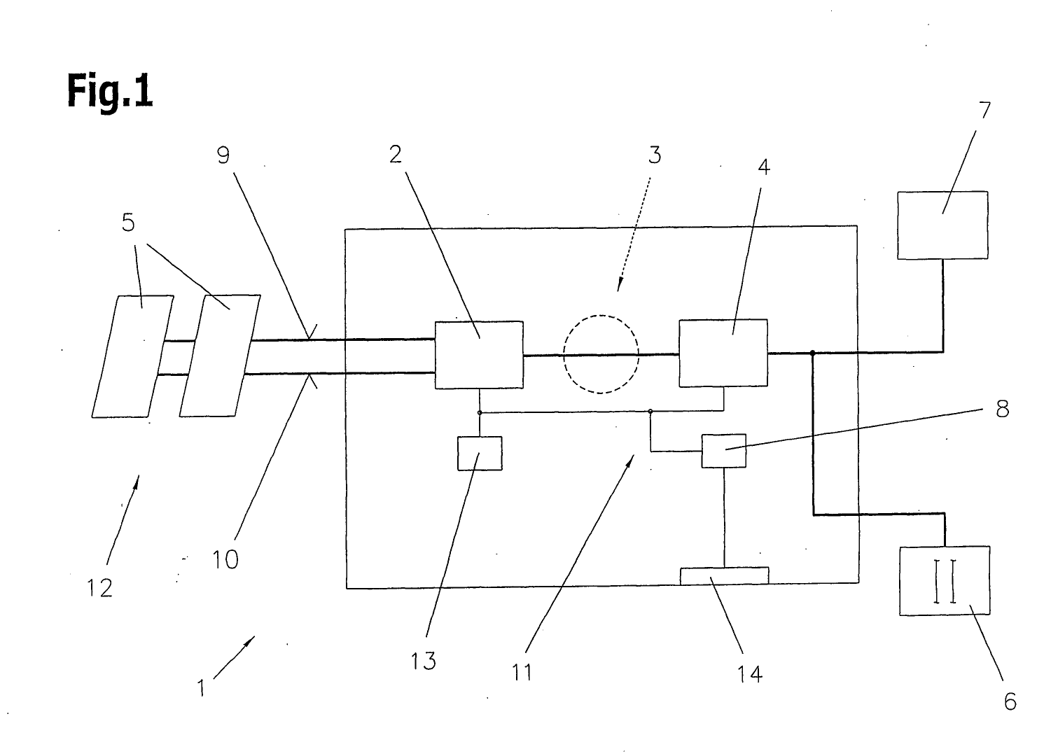

FIG. 1 shows a schematic overview illustration of a known inverter of a photovoltaic system; and

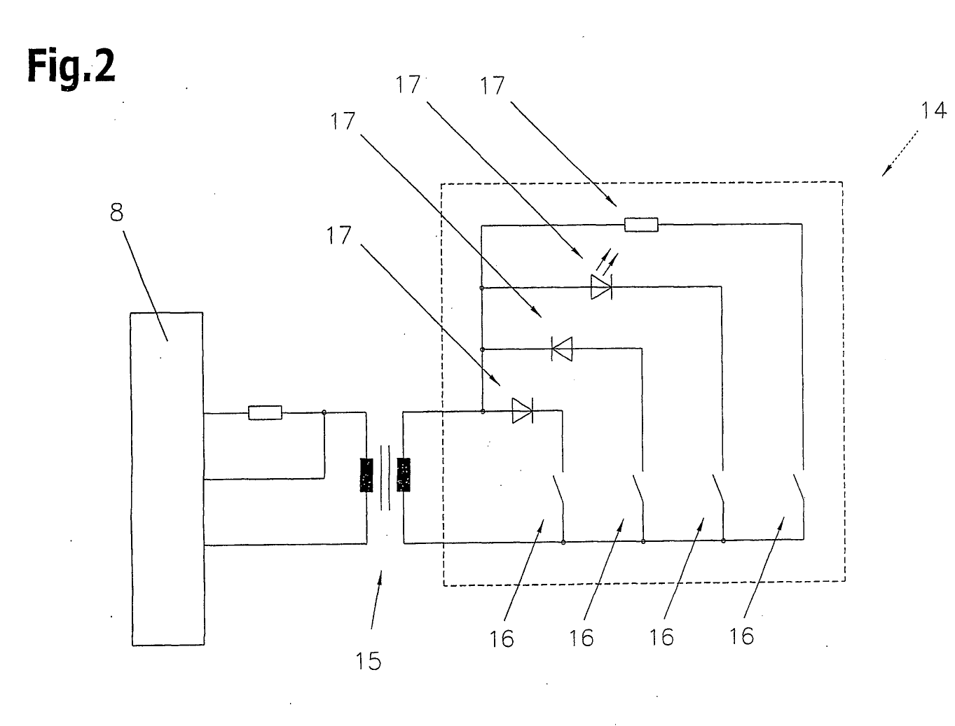

FIG. 2 shows a circuit according to the invention for the galvanic isolation of the front panel.

As an introduction, it is first established that the same parts of the exemplary embodiment are provided with the same reference numbers.

A construction of a known inverter 1 is shown in FIG. 1 in the detail of a HF inverter. As the individual components or subassemblies and functions of inverters 1 are already known from the prior art, these are not covered in detail in the following.

The inverter 1 has at least one input DC-DC transformer 2, an intermediate circuit 3 and an output DC/AC transformer 4. A power source 12 or a power generator is connected to the input DC/DC transformer 2, which power source or power generator is preferably formed from one or a plurality of solar modules 5 connected in parallel or in series to one another. The inverter 1 and the solar modules 5 are also designated as photovoltaic system or as PV system. The output of the inverter 1 or of the output DC/AC transformer 4 can be connected to a supply network 6 such as a public or private AC network or a multiphase network and/or to at least one electrical consumer 7 which constitutes a load. For example, a consumer 7 is formed by means of a motor, refrigerator, radio, etc. Likewise, the consumer 7 can also constitute a domestic supply. The individual components of the inverter 1, such as the input DC/DC transformer 2, etc. can be connected to a control device 8 via a databus 11.

Preferably, an inverter 1 of this type is used as what is known as a network-coupled inverter 1, whose power management is optimised to feed as much power as possible into the supply network 6. As is known from the prior art, the consumers 7 are supplied via the supply network 6. Of course, a plurality of inverters 1 connected in parallel can also be used. As a result, more power can be provided for operating the consumers 7. This power is delivered by the power source 12 in the form of a d.c. voltage which is connected to the inverter 1 via two connection lines 9, 10.

The control device 8 or the controller of the inverter 1 is for example formed by means of a microprocessor, microcontroller or computer. Using the control device 8, a corresponding control of the individual components of the inverter 1, such as the input DC/DC transformer 2 or the output DC/AC transformer 4, particularly the switching elements arranged therein, can be undertaken. In the control device 8, the individual regulation or control processes are stored to this end by means of corresponding software programs and/or data or characteristics.

Furthermore, a front panel 14 is connected to the control device 8, by means of which the user can configure the inverter 1 or for example change and display operating states or parameters. A corresponding standard must usually be fulfilled so that a front panel 14 of this type can be used, for example on the front of the inverter 1. This standard provides that the front panel 14 is galvanically isolated from the remaining electronics, such as the input DC/DC transformer 2, intermediate circuit 3, output DC/AC transformer 4 and the control device 8. As a result, the required safety for the user is ensured.

According to the invention, this galvanic isolation takes place by means of a transformer 15, the primary side of which is connected to the control device 8 and the secondary side of which is connected to the front panel 14. According to the invention, it is further provided that the secondary side of the transformer 15 does not have a voltage or current supply of its own.

A galvanic isolation of this type is shown in FIG. 2. The front panel 14 for example comprises four operating elements 16, such as keys, which are integrated into a membrane keypad for example. In this case, each operating element 16 is connected in series to at least one component 17, such as a resistor, a diode or a resonant circuit, so that the transformer 15 is loaded with a corresponding component 17 in the case of the actuation of each operating element 16. In the case of the actuation of an operating element 16, the circuit is therefore closed on the secondary side and the transformer 15 is loaded by means of the component 17 connected in series. If it is necessary that two operating elements 16 must be actuated at the same time for example, a circuit results in turn in which the transformer 15 is loaded by means of the parallel connection of the components 17 connected to the actuated operating elements 16 in series. Of course, no component 17 may also be connected to an operating element 16 in series, so that the secondary winding of the transformer 15 is short-circuited when this key is pressed. By using keys as operating elements 16, it is advantageously achieved that the transformer 15 is only loaded when the operating elements 16 are actuated. That is to say also, however, that power is only consumed in the case of the actuation of the operating elements 16.

So that which operating element 16 of the secondary side was actuated can now be identified by the control device 8 connected on the primary side of the transformer 15, the components 17 have a different resistance or internal resistance, a different diode flow voltage, etc. The transformer 15 is therefore loaded differently by each operating element 16 if at least one operating element 16 is actuated.

This loading is preferably identified by the control device 8 in that the latter applies a voltage signal to the primary side of the transformer 15. In the case of the actuation of at least one operating element 16, the voltage signal is changed on the secondary side in accordance with the component 17 which is connected to the key. This change spreads in accordance with the transformation ratio of the transformer 15 to the primary side, so that this is identified by means of the control device 8.

Preferably a rectangular signal is essentially used as a voltage signal so that a relatively smaller transformer 15, such as for example a high-frequency transformer 15, can be used. To this end, it is important for the voltage signal that this has a rising or falling edge which is as steep as possible. The voltage signal should therefore have the shape of a mentioned rectangle or a trapezoid or the like. The frequency of the voltage signal is in this case adapted to the polling time so that a loading, that is to say an actuation of an operating element 16, is reliably identified. The operating elements 16 are therefore only polled at certain times, as a result of which additional power is saved. Accordingly, the voltage signal is generated by the control device 8 as a function of the polling time and applied to the primary side of the transformer 15 via a series resistor. The polling of the voltage signal for identifying the actuation of an operating element 16 preferably takes place however directly on the primary side of the transformer 15, wherein the polling is carried out by the control device 8 in accordance with the polling time. The polling time or the frequency of the voltage signal is in this case essentially independent of the transformer 15 used, in an advantageous manner, as the change of the voltage signal can only be identified and evaluated shortly after the appearance of the loading. A low frequency can therefore also be used for the voltage signal as a saturation of the transformer 15, which occurs later, has no effects on the evaluation of the voltage signal. As unnecessary power is used in the saturation, however, this state should be avoided nonetheless. The frequency can be adapted to the type of the transformer 15 so that an actuation of an operating element 16 is reliably identified and power is saved at the same time.

So that, after the identification of a change of the voltage signal on the primary side of the transmitter 15, this change can be assigned to one or a plurality of actuated operating elements 16, corresponding reference values are preferably stored in the control device 8. These are accordingly compared with the current change of the voltage signal and assigned to at least one operating element 16. Accordingly, two or more operating elements 16 can also be pressed at the same time, wherein a different voltage signal results for each combination of the actuation of the operating elements 16. This is particularly to be traced back to the dimensioning of the components 17, so that a reliable identification of all combinations is ensured.

So, after the change of the voltage signal has been assigned to a reference value, a corresponding action, which is assigned to each operating element 16 or each combination, is executed. An action can for example be a change of the operation type, the changing of parameters, a menu control or similar.

Whether the action was executed successfully is preferably displayed to the user by means of a display. This is controlled by the control device 8 accordingly, so that the user can read off the changed parameters, the current operating state, etc., as is generally known from the prior art.

So, the display can also be connected to the control device 8 via the databus 11, for example. Thus, the front panel 14 according to the invention can be combined with a conventional display.

In addition, which operating element 16 is being actuated or whether this was correctly actuated can be shown to the user via the front panel 14 according to the invention. Preferably, this takes place in such a manner that light-emitting diodes are used as components 17 or light-emitting diodes are connected in series or in parallel in addition to the components 17. These light-emitting diodes illuminate when the corresponding operating element 16 is actuated or a combination of operating elements 16 is actuated. The prerequisite for this is a satisfactory power transmission, that is to say that the amplitude of the rectangular signal is adapted to the voltage required for the light-emitting diodes. Thus, feedback about the operating element(s) 16 actuated is realised in an advantageous manner for the user with the method according to the invention or the front panel 14 according to the invention.

In general, it may also be mentioned that, as described, although the assignment of the voltage signal to one or a plurality of operating elements 16 and the execution of the assigned action is carried out by the control device 8, a separate control device can of course, however, also be used for this purpose. The invention is however also independent of the distance between the front panel 14 and the transformer 15, of the distance between the operating elements 16 and the components 17 and/or of similar things. For example, the operating elements 16 can be integrated in a membrane keypad which is connected to the components 17 via lines which are arranged on a circuit board together with the transformer 15, wherein the primary side of the transformer 15 is in turn connected to the control device 8 via lines. In a further configuration, the components 17, the light-emitting diodes and the operating elements 16 can be integrated in the membrane keypad—which in this case corresponds to the front panel 14—and be connected via lines to the transformer 15 which is arranged on the circuit board of the device and connected to the control device 8. These examples accordingly show that the galvanic isolation of the front panel 14 can be realised very flexibly and simply. Accordingly, the transformer 15 can also be placed at any desired place.

1-9. (canceled)

10. Method for the identification of an actuation of at least one of a plurality of galvanically isolated operating elements (16) of a front panel (14) of an inverter (1), wherein operating elements (16) are connected in series to different components (17), and when actuating at least one operating element (16) on a secondary side of a transformer (15), this is loaded and the loading is identified and evaluated on a primary side of the transformer (15) by a control device (8) and is assigned to the at least one actuated operating element (16), wherein a voltage signal is applied on the primary side of the transformer (15) and the actuation at least of one operating element (16) is identified and evaluated on the voltage- or current-supply-free secondary side of the transformer (15) by means of the different changing of the voltage signal on the primary side of the transformer (15).

11. Method according to claim 10, wherein for assigning the at least one actuated operating element (16), the changed voltage signal is compared with reference values stored in the control device (8).

12. Method according to claim 11, wherein a reference value is stored for each operating element (16) and a reference value is stored or established for combinations of at least two operating elements (16).

13. Method according to claim 10, wherein the voltage signal is essentially formed by a rectangular signal.

14. Method according to claim 10, wherein a display is activated in the case of the actuation of an operating element (16).

15. Front panel (14) for an inverter (1) with a plurality of galvanically isolated operating elements (16), wherein the operating elements (16) are connected on a secondary side of a transformer (15) and are connected to different components (17) in series connection, wherein the transformer (15) is loaded in the case of the actuation of at least one operating element (16), and wherein a primary side of the transformer (15) is connected to a control device (8) for evaluating the loading and assignment of the at least one actuated operating element (16), and wherein a device for generating a voltage signal for identifying an actuation at least of one of the operating elements (16) arranged on the voltage- or current-supply-free secondary side of the transformer (15) is connected to the primary side of the transformer (15), so that the transformer (15) is loaded differently in the case of the actuation of different operating elements (16).
